(19) United States
(12) Patent Application Publication
(10) Pub. No.: US 2016/0147366 A1
(43) Pub. Date: May 26, 2016

(54) APPARATUSES, METHODS AND COMPUTER PROGRAMS FOR EXPANDING THE USE OF TOUCH-SENSITIVE INPUT APPARATUS

(71) Applicant: NOKIA TECHNOLOGIES OY, Espoo (FI)

(72) Inventors: Darry COTTON, Cambridgeshire (GB); Michael ASTLEY, Waterbeach (GB); Richard WHITE, Huntingdon (GB); Andrew MATTHEWS, Cambridge (GB)

(21) Appl. No.: 14/904,161

(22) PCT Filed: Jun. 25, 2014
(86) PCT No.: PCT/FI2014/050514

§ 371 Date: Jan. 11, 2016

(30) Foreign Application Priority Data
Jul. 18, 2013 (GB) 1312879.8

(51) Int. Cl. G06F 3/041; G06F 3/044

(52) U.S. Cl. CPC G06F 3/0416; G06F 3/044; G06F 2203/04106; G06F 2203/04108; G06F 2203/04103

(57) ABSTRACT

An apparatus comprising: one or more conductive paths for transporting charge carriers; and measurand-responsive material, wherein the measurand-responsive material is configured to respond to a measurand and form an active electrode, where sufficient measurand is present, the formed active electrode interconnecting to at least one of the one or more conductive paths.

### TECHNOLOGICAL FIELD

Embodiments of the present invention relate to expanding the use of touch-sensitive input apparatus.

### BACKGROUND

It is now common practice to use a touch-sensitive input apparatus as an input interface to an electronic device.

Some touch-sensitive input apparatus have a capacitive touch input region comprising a plurality of active electrodes. Each electrode has an associated electric field. When a user touches the capacitive touch input region, the user's finger interferes with an electric field, and this interference may be detected as a touch input.

The use of touch-sensitive input apparatus has been expanded. For example, some touch-sensitive input apparatus have been developed that expand the options for user input.

For example, some touch-sensitive input apparatus allow a user to make not only one touch input but also two or more simultaneous touch inputs.

For example, some touch-sensitive input apparatus allow a user to make a touch input not only by touching the capacitive touch input region but also, without touching the capacitive touch input region, by bringing a digit close to the capacitive touch input region.

### BRIEF SUMMARY

According to various, but not necessarily all, embodiments of the invention there is provided an apparatus comprising: one or more conductive paths for transporting charge carriers; and measurand-responsive material, wherein the measurand-responsive material is configured to respond to a measurand and form an active electrode, where sufficient measurand is present, the formed active electrode interconnecting to at least one of the one or more current paths.

According to various, but not necessarily all, embodiments of the invention there is provided a computer program that when loaded into a processor enables: switching between a first operational mode during which a detected input signal from a particular location in a capacitive touch input region is determined as a user touch input at that particular location, to a second operational mode during which a detected input signal from a particular location in the capacitive touch input region is determined as a presence of a measurand at the particular location.

According to various, but not necessarily all, embodiments of the invention there is provided a method comprising: providing on a substrate one or more conductive paths for transporting charge carriers; and providing measurand-responsive material, wherein the measurand-responsive material is configured to respond to a measurand and form an active electrode, where sufficient measurand is present, the formed active electrode interconnecting to at least one of the one or more conductive paths.

According to various, but not necessarily all, embodiments of the invention there is provided an overlay that enables use of a touch-sensitive input apparatus to detect a measurand, the overlay comprising a surface for adhesion to a surface of the touch-sensitive input apparatus, wherein the overlay is configured to simulate a touch input at the touch-sensitive input apparatus where sufficient measurand is present.

According to various, but not necessarily all, embodiments of the invention there is provided a method of using a touch-sensitive input device to detect a measurand, comprising: providing an overlay to a surface of the touch-sensitive device, wherein the overlay simulates a touch input at the touch-sensitive input device where sufficient measurand is present.

### BRIEF DESCRIPTION

For a better understanding of various examples that are useful for understanding the brief description, reference will now be made by way of example only to the accompanying drawings in which:

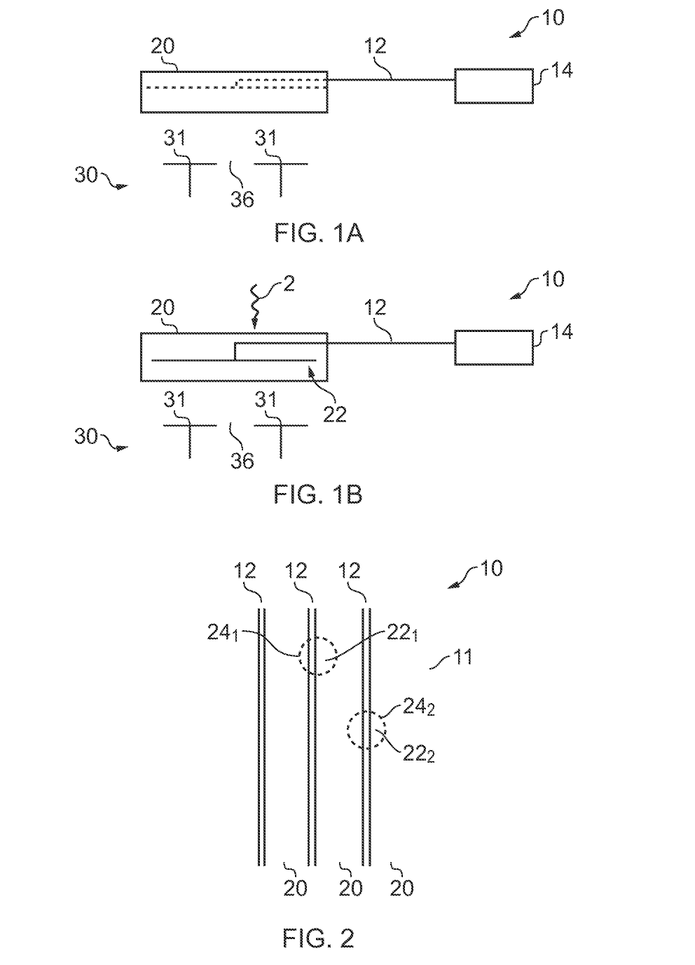

FIGS. 1A and 1B illustrate an example of a measurand apparatus for detecting a measurand;

FIG. 2 illustrates an example of the measurand apparatus illustrated in FIGS. 1A and 1B;

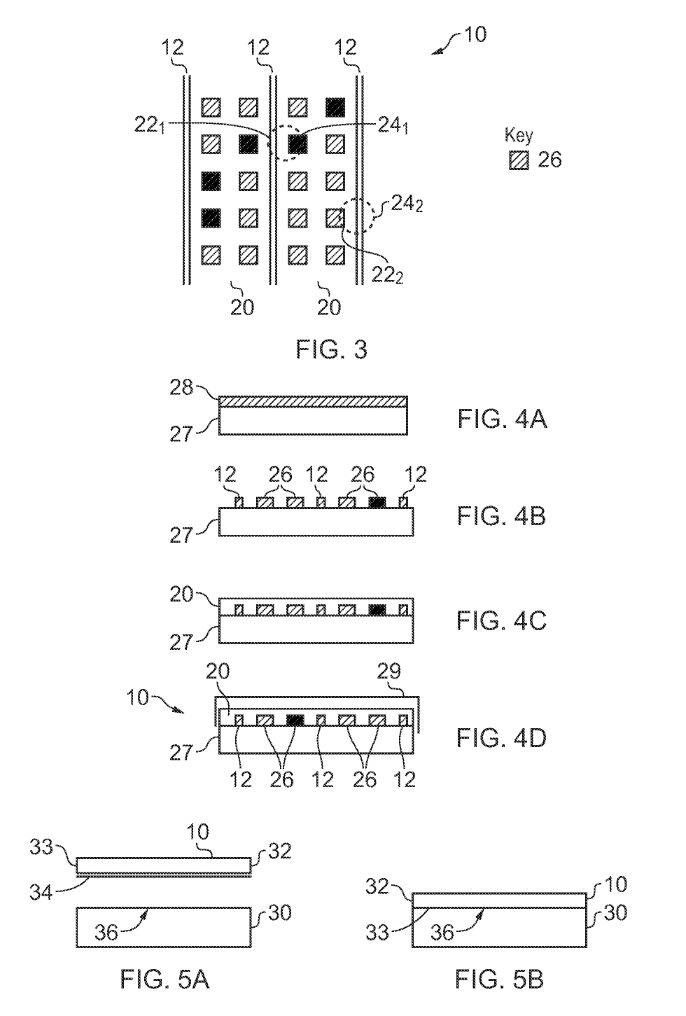

FIG. 3 illustrates another example of the measurand apparatus illustrated in FIGS. 1A and 1B;

FIGS. 4A to 4D illustrate an example of a method for manufacturing an example of the measurand apparatus;

FIGS. 5A and 5B illustrate an example of using the measurand apparatus as an accessory for a touch-sensitive input apparatus, post-manufacture;

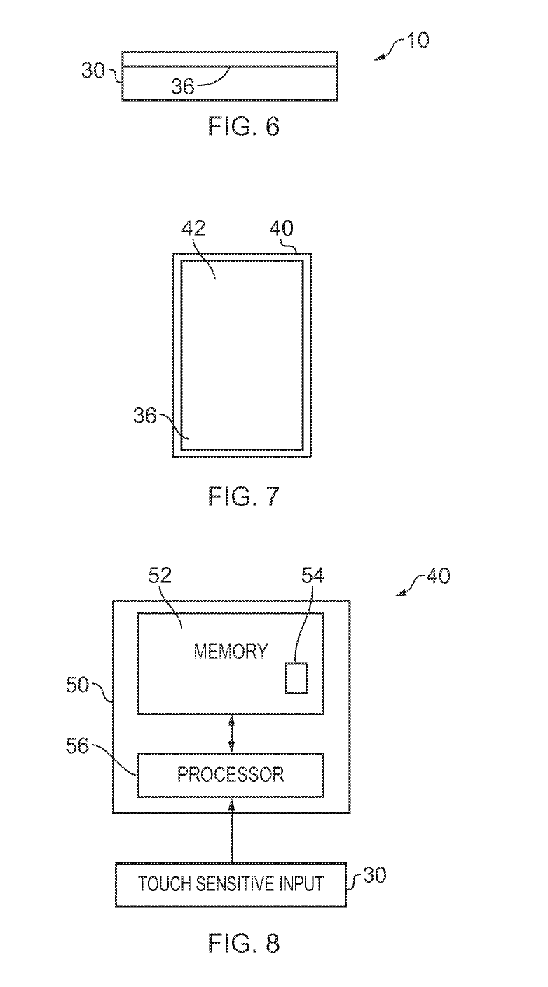

FIG. 6 illustrates an example of integrating the measurand apparatus with the touch-sensitive input apparatus, at manufacture;

FIG. 7 illustrates an electronic device comprising a touch-sensitive input apparatus and measurand apparatus; and

FIG. 8 illustrates an example of a controller that interprets the output of a touch-sensitive input apparatus.

### DETAILED DESCRIPTION

In this patent application, the term ‘measurand’ is used to denote something that may be measured. Measurement in this context encompasses both quantitative and qualitative measurement and is synonymous with detection. A measurand may alternatively be referred to as a parameter.

In this patent application, the term ‘measurand-responsive material’ is used to denote material that responds to the presence of the measurand. In some, but not necessarily all examples, the response may be that one or more electrical characteristics of the material change. A measurand-responsive material may alternatively be referred to as a parameter-responsive material.

FIGS. 1A and 1B illustrate an example of an apparatus 10 for detecting a measurand, which may also be referred to as a measurand apparatus 10.

The apparatus 10 comprises one or more conductive paths 12 for transporting charge carriers. In use, the one or more conductive paths 12 are connected to a source/sink 14 of charge carriers such as, for example, electrical ground.

An electrical ground may be provided by the apparatus 10 itself or may be provided by a user's body.

The apparatus 10 also comprises measurand-responsive material 20. The measurand-responsive material 20, in the absence of sufficient measurand 2, is ‘inactive’ and does not enable simulation of a user touch input. The measurand-responsive 20 in the presence of sufficient measurand 2 is ‘active’ and enables simulation of a user touch input.

Therefore, where sufficient measurand 2 is present, the measurand-responsive material 20 forms an active electrode 22. The formed active electrode 22 is interconnected to at least one of the one or more conductive paths 12 and simulates a touch input.

The measurand-responsive material 20 is configured to overlie a touch-sensitive input apparatus 30. Where the measurand-responsive material 20 is exposed to sufficient measurand 2, one or more active electrodes 22 are formed. An active electrode 22 simulates one or more touch inputs at the touch-sensitive input apparatus 30. The apparatus 10 is therefore configured to enable a touch-sensitive input apparatus 30 to detect the measurand 2 by simulating one or more touch inputs at the touch-sensitive input apparatus 30.

The measurand-responsive material 20 is configured not only to form the active electrode 22 but also to interconnect the active electrode 22 to at least one conductive path 12.

The measurand-responsive material 20 has a configuration that changes in the presence of sufficient measurand 2. It changes from a first non-actuated configuration, as illustrated in FIG. 1A, in which an active electrode 22 is not formed to a second actuated configuration, as illustrated in FIG. 1B, in which an active electrode 22 is formed and a touch input is simulated.

For example, the measurand-responsive material 20 may be configured to significantly change its electrical properties (electrical resistance and/or capacitance and/or inductance) in response to the measurand 2. The measurand 2 may, for example be absorbed or adsorbed by the measurand-responsive material 20. The measurand-responsive material 20 may be configured to have a reduced sheet resistance in response to the measurand.

In some but not necessarily all examples, the measurand-responsive material 20 remains in the second configuration temporarily, for example, only while sufficient measurand 2 is present.

In some but not necessarily all examples, the measurand 2 is humidity and the measurand-responsive material 20 is responsive to humidity. In these examples, the measurand-responsive material 20 may comprise graphene oxide or boron nitride. Both graphene oxide and boron nitride have an electrical resistance that decreases by several orders of magnitude in the presence of humidity.

As an example, by controlled exhaling (blowing) a user can control when and where humidity is applied to the measurand-responsive material 20 and can therefore control when and where a touch input to the touch-sensitive input apparatus 30 is simulated.

In some but not necessarily all examples, the measurand 2 is applied pressure and the measurand-responsive material 20 is responsive to applied pressure. In these examples, the measurand-responsive material 20 may comprise piezoresistive material or a quantum tunnelling composite. By controlled application of pressure, a user can control when and where a touch input to the touch-sensitive input apparatus 30 is simulated.

In some but not necessarily all examples, the measurand 2 is applied light and the measurand-responsive material 20 is responsive to applied light. In these examples, the measurand-responsive material 20 may comprise photo-conductive material. By controlled application of light, for example using a laser pointer, a user can control when and where a touch input to the touch-sensitive input apparatus 30 is simulated.

In some but not necessarily all examples, the apparatus 10 may comprise a single measurand-responsive material 20 which is responsive to a single measurand 2.

In some but not necessarily all examples, apparatus 10 may comprise different areas of measurand-responsive material 20 each of which is responsive to a different measurand 2.

The touch-sensitive input apparatus 30 comprises drive circuitry configured to project electric fields into free space beyond a capacitive touch screen input region 36 and comprises detection circuitry configured to detect variations to one or more of the electric fields. The detection may be configured to measure a change in capacitance at a single electrode 31 caused by, for example, a proximal finger (self-capacitance) or may be configured to measure change in capacitance between two electrodes 31 caused by, for example, a proximal finger (mutual capacitance).

FIG. 2 illustrates an example of the apparatus 10 illustrated in FIGS. 1A and 1B.

A plurality of narrow conductive paths 12 extend in parallel over a sensing area 11 of the apparatus. In this example, the conductive paths 12 are regularly spaced, with a separation between them significantly greater than their width.

In some, but not necessarily all examples, the conductive paths 12 are formed from transparent conductive material such indium tin oxide, carbon nanotubes, silver nanowires, a mesh of copper, silver or other metal.

In use, the conductive paths 12 are connected to a source/sink of charge carriers such as, for example, electrical ground (not illustrated in FIG. 2).

In this example, but not necessarily all examples, the measurand-responsive material 20 overlies the plurality of conductive paths 12 as a continuous planar layer. The planar layer may be less than 1 pm thick.

When sufficient measurand 2 is present at a first area 24₁, the distributed measurand-responsive material 20 forms a first active electrode 22₁ distributed over the first area 24₁. The formed first active electrode 22₁ is electrically interconnected to at least one of conductive paths 12. The first active electrode 22₁, electrically connected to a conductive path 12, simulates a user touch input at the position of the first area 24₁.

When sufficient measurand 2 is not present at the first area 24₁, the distributed measurand-responsive material 20 does not form a first active electrode 22₁ distributed over the first area 24₁. There is no formed first active electrode 22₁ electrically interconnected to at least one of conductive paths 12. No touch input is simulated.

When sufficient measurand 2 is present at the second area 24₂, the distributed measurand-responsive material 20 forms a second active electrode 22₂ distributed over the second area 24₂. The formed second active electrode 22₂ is interconnected to at least one of conductive paths 12. The second active electrode 22₂, electrically connected to a conductive path 12, simulates a user touch input at the position of the second area 24₂.

When sufficient measurand 2 is not present at the second area 24₂, the distributed measurand-responsive material 20 does not form a second active electrode 22₂ distributed over the second area 24₂. There is no formed second active electrode 22₂ interconnected to at least one of conductive paths 12. No touch input is simulated.

Sufficient measurand 2 may be present simultaneously at the first area 24₁ and at the second area 24₂. As a consequence, the formed first active electrode 22₁ simulates a first touch input at the first area 24₁ and the formed second active electrode 22₂ simulates a simultaneous second touch input at the second area 24₂.

Sufficient measurand 2 may be present sequentially at the first area 24₁ and then at the second area 24₂. As a consequence, the formed first active electrode 22₁ simulates a first touch input at the first area 24₁ and the formed second active electrode 22₂ simulates, at a later time, a second touch input at the second area 24₂.

FIG. 3 illustrates an example of the measurand apparatus 10 illustrated in FIGS. 1A and 1B.

The apparatus 10 illustrated in FIG. 3 is similar to the apparatus 10 illustrated in FIG. 2. It has a similar arrangement of conductive paths 12 and measurand-responsive material 20. However, in this example the apparatus 10 additionally comprises sub-electrodes 26.

In this example, the sub-electrodes are conductive elements that are used to enhance or augment the active electrode 22, when formed.

In this example, the measurand-responsive material 20 overlies the conductive paths 12 and the sub-electrodes 26 as a continuous layer. The layer may be less than 1 μm thick.

When sufficient measurand 2 is present at the first area 24₁, the distributed measurand-responsive material 20 forms a first active electrode 22₁ distributed over the first area 24₁. The formed first active electrode 22₁ electrically interconnects at least one sub-electrode 26 and at least one of the conductive paths 12. The combination of first active electrode 22₁ and sub-electrode 26, electrically connected to a conductive path 12, simulates a user touch input at least at the position of that sub-electrode 26.

When sufficient measurand 2 is not present at the first area 24₁, the distributed measurand-responsive material 20 does not form a first active electrode 22₁ distributed over the first area 24₁. There is no formed first active electrode 22₁. The sub-electrodes 26 and the conductive paths 12 are not electrically connected by the formed first electrode 22₁. The sub-electrodes are ‘floating’ (i.e. not electrically connected to a conductive path 12) and no touch input is simulated.

When sufficient measurand 2 is present at the second area 24₂, the distributed measurand-responsive material 20 forms a second active electrode 22₂ distributed over the second area 24₂. The formed second active electrode 22₂ electrically interconnects at least one sub-electrode 26 and at least one of the conductive paths 12. The combination of second active electrode 22₂ and sub-electrode 26, electrically connected to a conductive path 12, simulates a user touch input at least at the position of the sub-electrode 26.

When sufficient measurand 2 is not present at the second area 24₂, the distributed measurand-responsive material 20 does not form a second active electrode 22₂ distributed over the second area 24₂. There is no formed second active electrode 22₂. The sub-electrodes 26 and the conductive paths 12 are not electrically connected by the formed second electrode 22₂. The sub-electrodes are ‘floating’ (i.e. not connected to a conductive path 12) and no touch input is simulated.

Sufficient measurand 2 may be present simultaneously at the first area 24₁ and at the second area 24₂. As a consequence, the formed first active electrode 22₁ simulates a first touch input at the first area 24₁ and the formed second active electrode 22₂ simulates a simultaneous second touch input at the second area 24₂. The use of the sub-electrodes 26 improves the simulation of a touch input by increasing the capacitance of the first active electrode 22₁ and the second active electrode 22₂.

Sufficient measurand 2 may be present sequentially at the first area 24₁ and then at the second area 24₂. As a consequence, the formed first active electrode 22₁ simulates a first touch input at the first area 24₁ and the formed second active electrode 22₂ simulates, at a later time, a second touch input at the second area 24₂.

The use of the sub-electrodes 26 improves the simulation of a touch input by increasing the capacitance of the first active electrode 22₁ and the second active electrode 22₂.

The sub-electrodes 26 are distinct conductive regions. The regions are physically isolated from each other and form ‘islands’. The measurand-responsive material 20 is configured to electrically interconnect sub-electrodes 26 to conductive paths 12 and, possibly, electrically interconnect sub-electrodes 26 together in the presence of sufficient measurand 2.

In some but not necessarily all examples, the distinct sub-electrodes 26 are the same size and are arranged in rows and columns.

In some but not necessarily all examples, the distinct sub-electrodes 26 may be formed from conductive, optically transparent material, for example, indium tin oxide (ITO) or graphene.

FIGS. 4A to 4D illustrate an example of a method for manufacturing an example of the measurand apparatus 10.

As illustrated in FIG. 4A, a conductive layer 28 is formed as a continuous layer over a substrate 27.

In some but not necessarily all examples, the substrate 27 may be a plastic film such as, for example, Polyethylene naphthalate (PEN) or polyethylene terephthalate (PET).

In some but not necessarily all examples, the conductive layer 28 may be formed from indium tin oxide, carbon nanotubes, silver nanowires, a mesh of copper, silver or other metal.

As illustrated in FIG. 4B, the conductive layer 28 is patterned. It is completely removed from some areas of the substrate 27 and it is retained in other areas of the substrate 27.

The areas where the conductive layer 28 is retained form conductive paths(s) 12 and, in this example, sub-electrodes 26.

In some but not necessarily all examples, laser machining may be used to pattern the conductive layer 28.

As illustrated in FIG. 4C, a layer of measurand-responsive material 20 is applied as a continuous layer over the patterned conductive layer 28 and the exposed areas of the substrate 27.

The measurand-responsive material 20 physically interconnects conductive paths 12 and sub-electrodes 26.

The measurand-responsive material 20 may be a planar layer having a planar top surface or it may be a conformal layer, conforming to the underlying relief of the patterned conductive layer 28.

In some but not necessarily all examples, the measurand-responsive material 20 may be less than 1 μm thick.

As illustrated in FIG. 4D, optionally, a cover layer 29 is applied as a continuous layer over the measurand-responsive material 20. The cover layer 20, if present, protects the measurand-responsive material 20 while allowing transport of the measurand 2 to the measurand-responsive material 20.

The cover layer 29 may, for example be permeable or porous to the measurand 2.

Where the measurand 2 is humidity, and the measurand-responsive material 20 is, for example, graphene oxide or boron nitride, then the cover layer 29 may be polydimethylsiloxance (PDMS) which allows the transport of water vapour. This cover layer 29, and other cover layers, may be deposited by spray coating. The cover layer 29 may be less than 10 μm thick.

In some but not necessarily all examples, the substrate 27, the patterned conductive layer 28, the layer of measurand-responsive material 20 and the cover layer 29 (if present), may be optically transparent to the human eye.

The measurand-responsive material 20 is configured to respond to measurand 2 and form an active electrode 22, where sufficient measurand 2 is present. The formed active electrode 22 interconnects to at least one of the one or more conductive paths 12. The conductive paths 12 are for transporting charge carriers to/from the active electrode 22, which simulates a touch input.

FIGS. 5A and 5B illustrate an example of a measurand apparatus 10 for detecting a measurand as previously described in relation to FIGS. 1 to 4. In this example, but not necessarily all examples, the measurand apparatus 10 is an accessory for a touch-sensitive input apparatus 30.

In FIG. 5A, the measurand apparatus 10 for detecting a measurand is separate from the touch-sensitive input apparatus 30. The apparatus 10 is an overlay 32, that accessorizes the touch-sensitive input apparatus 30 by overlaying a capacitive touch input region 36 of the touch-sensitive input apparatus 30.

The touch-sensitive apparatus 30 is capable of touch detection but not measurand detection.

The overlay 32 comprises on a lower surface a releasable backing layer 34 which is releasably attached to the lower surface by adhesive 33. The releasable backing layer 34 may be removed by a user to expose the adhesive 33. The apparatus 10, in the form of overlay 32, may then be adhered to the capacitive touch input region 36 of the touch-sensitive input apparatus 30 as illustrated in FIG. 5B.

In some but not necessarily all examples, the apparatus 10, in the form of overlay 32, may be removed from the capacitive touch input region 36 of the touch-sensitive input apparatus 30. In some but not necessarily all examples, the apparatus 10, in the form of overlay 32, may be disposable such that it is unsuitable for re-use after it has been removed.

In FIG. 5B, the touch-sensitive input apparatus 30 comprises the apparatus 10, in the form of overlay 32. The apparatus 10 has been adhered to the capacitive touch input region 36 of the touch-sensitive input apparatus 30 as a post-manufacture user-modification of the touch-sensitive input apparatus 30.

In the example of FIGS. 5A and 5B, the touch-sensitive input apparatus 30 has a first operational mode before the overlay 32 is attached (FIG. 5A) and has a second operational mode after the overlay 32 is attached (FIG. 5B).

During the first operational mode, a detected input at the capacitive touch input region 36 at a particular location is determined as a touch input at that particular location.

During the second operational mode, a detected input at the capacitive touch input region 36 at a particular location is determined as a presence of the measurand 2 at the particular location.

In the second mode of operation, in one example, any detected input at the capacitive touch input region 36 at a particular location is determined as a presence of the measurand 2 at the particular location. In this example, the apparatus 10 may be, but is not necessarily, configured to prevent a touch at the apparatus 10 being detected as a touch input at the touch-sensitive apparatus 30.

In another example, a detected input at the capacitive touch input region 36 at a particular location is determined, after disambiguation, as a presence of the measurand 2 at the particular location or a touch input at the particular location. Disambiguation may, for example, occur based on the area of the capacitive touch input region 36 that is activated. An actual touch input would be expected to have an active area at the capacitive touch input region 36 that is small and well defined. Whereas, in some but not necessarily all examples, a simulated touch input, caused by a measurand 2, may be expected to have an active area at the capacitive touch input region 36 that is larger and perhaps less well defined. The touch-sensitive input apparatus 30 with overlay 32 attached is therefore capable, in this example, of both touch detection using the touch-sensitive apparatus 30 to detect touch and also is capable of measurand detection when the measurand apparatus 10 is used to simulate a touch input at the touch-sensitive apparatus 30.

It will therefore be appreciated that FIG. 5A illustrates an overlay 32 that enables use of a touch-sensitive input apparatus 30 to detect a measurand 2. The overlay 32 comprises a surface for adhesion to a surface of the touch-sensitive input apparatus 30. The overlay 32, when adhered, is configured to simulate a touch input at the touch-sensitive input apparatus 30 where sufficient measurand 2 is present.

It will therefore be appreciate that FIG. 5A and 5B, enable a method of using a touch-sensitive input device 30 to detect a measurand, comprising: providing an overlay 32 to a surface of the touch-sensitive device, wherein the overlay 32 simulates a touch input at the touch-sensitive input device where sufficient measurand 2 is present.

In the example of FIG. 6, the measurand apparatus 10 is integrated into a capacitive touch input region 36 of a touch-sensitive input apparatus 30 during manufacture of the touch-sensitive input apparatus 30. The measurand apparatus 10 is then an integral part of the touch-sensitive apparatus 30. The resulting product may be capable of touch detection using the touch-sensitive apparatus 30 to detect touch and also capable of measurand detection using the measurand apparatus 10 to simulate a touch input at the touch-sensitive apparatus 30.

FIG. 7 illustrates an electronic device 40 that comprises a touch-sensitive input apparatus 30. In this example, the touch-sensitive input apparatus 30 is a touch-sensitive display 42. The capacitive touch input region 36 extends over the display.

The electronic device 40 may be a user device that is portable and carried on the user or by the user.

The electronic device may, for example, be a portable tablet device of a size equivalent to A4 or A5, for example. That is of a size capable of being carried in a briefcase.

The electronic device may, for example, be a hand-portable electronic device that is sized to be carried in a palm of a human hand and to fit into a jacket pocket.

The electronic device 40 may be a touch-sensitive input apparatus 30 before the apparatus 10 has been applied post-manufacture (FIG. 5A).

The electronic device 40 may be a touch-sensitive input apparatus 30 after the apparatus 10 has been applied post-manufacture (FIG. 5B).

The electronic device 40 may be a touch-sensitive input apparatus 30 to which the apparatus 10 has been integrated at manufacture (FIG. 6).

The electronic device 20, with measurand apparatus 10, may enable a touch-sensitive input apparatus 30 to be used as an input device other than by touching it.

For example, when the measurand 2 is humidity a user may be able to actuate the touch-sensitive input apparatus 30 by blowing onto the apparatus 10. The apparatus 10 transforms the measurand 2 (humid air from a user's mouth) into a simulated touch at the touch-sensitive input apparatus 30. The user, by blowing onto the apparatus 10, can provide a point input or a trace or gesture input by controlled blowing. For example, by tracing the measurand 2 across the sensing area 11 of the measurand apparatus 10, a user can input a trace input at the touch-sensitive input apparatus 30. The electronic device 40 is thus able to be used by a person who temporarily or permanently does not have use or control or presence of their hands or digits or is permanently or temporarily disabled such that use of a standard touch-sensitive input apparatus is not possible or easy. The measurand apparatus 10 enables a standard touch-sensitive input apparatus 30 to be temporarily or permanently augmented or converted so that a user can use the standard touch-sensitive input apparatus 30 without touching it.

FIG. 8 illustrates an example of a controller 50 that interprets the output of a touch-sensitive input apparatus 30. The controller 50 may be a part of the touch-sensitive input apparatus 30 or, as illustrated in this example, a part of an electronic device 40 that uses the touch-sensitive input apparatus 30 as an input interface to the electronic device 40.

Implementation of controller 50 can be in hardware alone (a circuit, a processor), have certain aspects in software including firmware alone or can be a combination of hardware and software (including firmware).

The controller 50 may be implemented using instructions that enable hardware functionality, for example, by using executable computer program instructions in a general-purpose or special-purpose processor that may be stored on a computer readable storage medium (disk, memory etc) to be executed by such a processor.

In this example, the controller 50 comprises a processor 56 and a memory 52. The processor 56 is configured to read from and write to the memory 52. The processor 56 may also comprise an output interface via which data and/or commands are output by the processor 56 and an input interface via which data and/or commands are input to the processor 56.

The memory 52 stores a computer program 54 comprising computer program instructions (computer program code) that controls the operation of the apparatus 40 when loaded into the processor 56. The computer program instructions, of the computer program 54, provide the logic and routines that enables the controller 50 to interpret the output of the touch-sensitive input apparatus 30. The processor 56 by reading the memory 52 is able to load and execute the computer program 54.

The controller 50 therefore comprises: at least one processor 56; and
at least one memory 52 including computer program code 54
the at least one memory and the computer program code 54 configured to, with the at least one processor 56, cause the apparatus 40 at least to perform:
switching between a first operational mode during which a detected input signal from a particular location in a capacitive touch input region 36 is determined as a user touch input at that particular location, to a second operational mode during which a detected input signal from a particular location in the capacitive touch input region is determined as a presence of a measurand at the particular location.

The computer program 54 when loaded into the processor 56 enables switching between the first operational mode during which a detected input signal from a particular location in a capacitive touch input region is determined as a user touch input at that particular location, to the second operational mode during which a detected input signal from a particular location in the capacitive touch input region is determined as a presence of a measurand 2 at the particular location.

The computer program 54 may arrive at the apparatus 40 via any suitable delivery mechanism. The delivery mechanism may be, for example, a non-transitory computer-readable storage medium, a computer program product, a memory device, a record medium such as a compact disc read-only memory (CD-ROM) or digital versatile disc (DVD), an article of manufacture that tangibly embodies the computer program 54. The delivery mechanism may be a signal configured to reliably transfer the computer program 54. The apparatus 40 may propagate or transmit the computer program 54 as a computer data signal.

Although the memory 52 is illustrated as a single component it may be implemented as one or more separate components some or all of which may be integrated/removable and/or may provide permanent/semi-permanent/dynamic/cached storage.

Although the processor 56 is illustrated as a single component it may be implemented as one or more separate components some or all of which may be integrated/removable.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:
(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.”

As used here ‘module’ refers to a unit or apparatus that excludes certain parts/components that would be added by an end manufacturer or a user. The apparatus 10 may be a module, the touch-sensitive input apparatus 30 (without the apparatus 10) may be a module, the touch-sensitive input apparatus 30 (with the apparatus 10) may be a module.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1-41. (canceled)

42. An apparatus comprising:
one or more conductive paths for transporting charge carriers; and
measurand-responsive material,
wherein the measurand-responsive material is configured to respond to a measurand and form an active electrode, where sufficient measurand is present, the formed active electrode interconnecting to at least one of the one or more current paths.

43. An apparatus as claimed in claim 42, wherein the measurand-responsive material is further configured to overlie a touch-sensitive input apparatus and simulate one or more touch inputs at the touch-sensitive input apparatus by forming one or more active electrodes, where sufficient measurand is present.

44. An apparatus as claimed in claim 42, wherein the apparatus is configured to enable a touch-sensitive input apparatus to detect the measurand by simulating one or more touch inputs at the touch-sensitive input apparatus.

45. An apparatus as claimed in claim 42, further comprising a plurality of distinct sub-electrodes, wherein the measurand-responsive material is configured to electrically interconnect the sub-electrodes together in the presence of sufficient measurand.

46. An apparatus as claimed in claim 42, wherein the measurand-responsive material is further configured to electrically interconnect sub-electrodes in the presence of sufficient measurand to at least one conductive path.

47. An apparatus as claimed in claim 45, wherein the distinct sub-electrodes are conductive islands.

48. An apparatus as claimed in claim 45, wherein the distinct sub-electrodes are the same size and are arranged in rows and columns as a regular array.

49. An apparatus as claimed in claim 45, wherein the distinct sub-electrodes are formed from conductive, optically transparent material.

50. An apparatus as claimed in claim 42, configured as an accessory for a touch-sensitive input apparatus.

51. An apparatus as claimed in claim 50, wherein the accessory is a disposable accessory that is configured to be applied to the touch-sensitive input apparatus by a user and removed from the touch-sensitive input apparatus by the user.

52. An apparatus as claimed in claim 42, configured as an overlay for a touch-sensitive apparatus, the overlay comprising releasable backing.

53. A touch-sensitive input apparatus comprising an apparatus, the apparatus comprising one or more conductive paths for transporting charge carriers; and
measurand-responsive material,
wherein the measurand-responsive material is configured to respond to a measurand and form an active electrode, where sufficient measurand is present, the formed active electrode interconnecting to at least one of the one or more current paths.

54. A touch-sensitive input apparatus as claimed in claim 53, wherein the apparatus is adhered to a capacitive touch input region of the touch-sensitive input apparatus as a post-manufacture modification of the touch-sensitive input apparatus.

55. A method comprising:
providing on a substrate one or more conductive paths for transporting charge carriers; and
providing measurand-responsive material, wherein the measurand-responsive material is configured to respond to a measurand and form an active electrode, where sufficient measurand is present, the formed active electrode interconnecting to at least one of the one or more conductive paths.

56. A method as claimed in claim 55, wherein the measurand-responsive material is deposited over the one or more conductive paths.

57. A method as claimed in claim 55, further comprising providing conductive sub-electrodes adjacent the one or more conductive paths.

58. A method as claimed in claim 57, wherein the measurand-responsive material is deposited over the one or more conductive paths and the conductive sub-electrodes.

59. A method as claimed in claim 57, wherein the conductive sub-electrodes and the one or more conductive paths are optically transparent to the human eye.

60. A method as claimed claim 55 further comprising depositing a cover layer over the measurand-responsive material, wherein the
cover material is configured to transport the measurand to the measurand-responsive material.

61. A method as claimed in claim 60, wherein the cover layer is an insulator that is optically transparent to the human eye.
